(19) United States
(12) Patent Application Publication
(10) Pub. No.: US 2024/0363908 A1
(43) Pub. Date: Oct. 31, 2024

(54) SEPARATORS HAVING OPPOSITELY-CHARGED REGIONS AND SECONDARY BATTERIES INCLUDING THE SAME

(71) Applicant: Washington University, St. Louis, MO (US)

(72) Inventors: Peng BAI, St. Louis, MO (US); Youngju LEE, St. Louis, MO (US)

(21) Appl. No.: 18/646,961

(22) Filed: Apr. 26, 2024

Related U.S. Application Data
(60) Provisional application No. 63/498,581, filed on Apr. 27, 2023.

(51) Int. Cl. H01M 10/42; H01M 50/403; H01M 50/414; H01M 50/457; H01M 50/46; H01M 50/489

(52) U.S. Cl. CPC H01M 10/4235; H01M 50/403; H01M 50/414; H01M 50/457; H01M 50/46; H01M 50/489; H01M 2300/0002

(57) ABSTRACT

An electrode assembly for an energy storage device, an energy storage device including one or more of the electrode assembly, and methods of assembling and operating the same. The electrode assembly includes an electrode, a counter electrode, and a separator between the electrode and the counter electrode. The separator includes a porous medium defining opposing major surfaces facing the electrode and the counter electrode, respectively, a first charged layer located at a first of the major surfaces, and a second, oppositely charged layer located at a second of the major surfaces.

### CROSS-REFERENCE TO RELATED APPLICATION

This application claims priority to U.S. Provisional Patent Application No. 63/498,581, filed Apr. 27, 2023, the disclosure of which is hereby incorporated by reference in its entirety.

### STATEMENT REGARDING FEDERALLY SPONSORED RESEARCH & DEVELOPMENT

This invention was made with government support under CBET1934122 awarded by the National Science Foundation. The government has certain rights in the invention.

### FIELD

The field of the present disclosure relates generally to energy storage devices, and more particularly, to porous separators used in energy storage devices that include a negatively charged region to regulate the transport of metal ions and a positively charged region to facilitate blocking the local metal penetration.

### BACKGROUND

Secondary batteries, also known as rechargeable batteries, are an existing type of energy storage device and one of the most critical components for a sustainable future. A secondary battery typically includes one or more battery cells that each include a positive electrode or cathode, a negative electrode or anode, an electrolyte ionically connecting the electrodes, and an ion-permeable separator disposed between the electrodes. Available separators for batteries include inert porous plastic films, which hold liquid electrolyte for metal ions to move between the electrodes, but also separate the cathode from anode to avoid direct chemical reaction that may lead to fires and explosions. Carrier metal ions, such as lithium ions, zinc ions, sodium ions, potassium ions, calcium ions, and/or magnesium ions, move between the anode and the cathode through the electrolyte and separator in response to an applied voltage. As a cell is discharged, metal ions move from the cathode toward the anode. As a cell is charged, metal ions move from the anode toward the cathode.

Increasing the power and energy density of secondary batteries while maintaining their safety will enable efficient mobile electronics, electric vehicles, and energy storage systems. Implementation of metal anodes is proposed as one of the ideal solutions for the current limitations due to their exceptional theoretical energy density. Examples of metal anodes include alkali metal anodes (e.g., lithium, sodium, and potassium metal anodes). One problem associated with alkali metal anodes is dendrite penetration through the porous separator at high current densities. Zinc (Zn) metal batteries have also been proposed. Aqueous zinc ion batteries (ZIBs) are excellent candidates for metal anode systems due to the abundance of Zn, high theoretical capacity (820 mAh g⁻¹), and the non-flammable nature of the aqueous electrolyte. However, similar to alkali metal anodes, Zn metal also suffers from dendritic growths which leads to rapid degradation and cell failures. Thus, reduction or elimination of dendritic growths and penetrations of porous separators remains a challenge towards implementing metal anode batteries to enable more economical and sustainable energy storage devices.

Attempts to alleviate the dendrite growth and penetration issue in metal anode batteries have been made but remain limited in their effectiveness. For example, the usage of novel electrolyte systems, additives, solid electrolytes, conductive host materials such as graphite fiber and porous metal current collectors, and addition of protective film on the electrodes have been proposed. Other proposed methods include introducing modifications of the separators to prevent dendrite growth and penetration therethrough. For example, introducing negative surface charges on the pore walls of separators have been exploited to enforce a uniform incoming Li-ion flux toward more uniform electrodeposition, but penetrations induced by localized high current densities still remain in available systems. These modified separators that include a negative surface charge in microscopic pores to regulate the transport of metal ions toward the electrode, and pristine commercial separators without the surface charge, cannot prevent metal penetration through local pores. Inspired by the theoretical analysis that negative surface charges can stabilize the electrodeposition, Han et al. investigated the effects of different surface charges on the pore walls of anodic aluminum oxide (AAO) membranes and commercial polyolefin separators in the electrodeposition of Cu. See J.-H. Han et al., Sci. Rep., 4, 7056 (2015) http://www.nature.com/articles/srep07056; J. H. Han et al., Sci. Rep., 6, 1-12 (2016) http://dx.doi.org/10.1038/srep28054. Following the same strategy, Zhi et al. designed negatively charged glass mat separators, which enabled the 200 Ah-class Zn metal batteries to cycle hundreds of times with high Coulombic efficiency. See J. Zhi et al., Sci. Adv., 6, 1-15 (2020). However, the effectiveness of the negatively charge separators in long-term operations and at high currents is yet to be carefully assessed. Localized metal penetrations via engineering defects of the separator, e.g., pores that were not coated with negative surface charges, especially at high currents, still need to be addressed.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, these statements are to be read in this light, and not as admissions of prior art.

### BRIEF DESCRIPTION

In one aspect, an electrode assembly for an energy storage device is provided. The electrode assembly includes an electrode, a counter electrode, and a separator between the electrode and the counter electrode. The separator includes a porous medium defining opposing major surfaces facing the electrode and the counter electrode, respectively, a first charged layer located at a first of the major surfaces, and a second, oppositely charged layer located at a second of the major surfaces.

In another aspect, an energy storage device is provided. The energy storage device includes one or more electrode assemblies. Each electrode assembly includes an electrode, a counter electrode, and a separator between the electrode and the counter electrode. For each electrode assembly, the separator includes a porous medium defining opposing major surfaces facing the electrode and the counter electrode, respectively, a first charged layer located at a first of the major surfaces, and a second, oppositely charged layer located at a second of the major surfaces.

In another aspect, a method of assembling an electrode assembly includes preparing a cathode by applying a cathodically active material to a cathode current collector; preparing an anode by applying an anodically active material to an anode current collector; preparing a separator by forming a positively charged layer that defines a first surface of a porous medium and forming a negatively charged layer that defines a second surface of the porous medium; and positioning the separator between the cathode and the anode such that the positively charged layer faces the cathode and the negatively charged layer faces the anode.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

Those of skill in the art will understand that the drawings, described below, are for illustrative purposes only. The drawings are not intended to limit the scope of the present disclosure in any way.

FIG. 1 is a schematic cross section of an example electrode assembly connected with an external device, the electrode assembly including an example bipolar separator in accordance with the present disclosure.

FIGS. 2A-2C depict metal penetration in positively charged, negatively charged, and untreated capillary cells, respectively.

FIG. 2D illustrates corresponding voltage responses in the capillary cells of FIGS. 2A-2C.

FIG. 2E illustrates penetration tests in coin cells that revealed that a bipolar separator design extended the penetration capacity by ˜140% at the current density of 10 mA cm⁻².

FIG. 2F illustrates cycle life data from Cu|Na coin cells as a model system for a holistic electrolyte design.

FIG. 3A depicts chronopotentiometry curves for capillary cells with different surface charges.

FIGS. 3B-3E depict morphologies of Zn dendrites, deposited inside capillaries with different surface charges and current densities.

FIGS. 3F-3L depict SEM images of Zn dendrites, collected from the capillaries of FIGS. 3B-3E after the deposition.

FIGS. 4A and 4B depict ion transport phenomena inside negative pores (FIG. 4A) and positive pores (FIG. 4B).

FIGS. 4C and 4D depict linear sweep voltammetry results inside split cells tested with different surface-charged separators and 0.1 M Zn(OTf)₂ aqueous electrolyte.

FIGS. 4E and 4F depict the schematic diagram for two layer separator systems with same surface charges (FIG. 4E), and a two layer bipolar separator system (FIG. 4F).

FIGS. 5A-5D depict chronopotentiometry curves for Zn symmetric cells with different surface-charged separator pairs.

FIG. 5E depicts penetration capacity of the Zn symmetric cells. The error bar denotes the standard deviations.

FIG. 5F depicts normalized penetration capacity of charged separator pair cells, compared with the control Zn symmetric cells.

FIGS. 6A-6L depict post-mortem images of penetrated separators.

FIGS. 7A-7L depict different morphologies of Zn deposition on the working electrode with the samples collected before the cell penetration and after the cell penetration.

FIGS. 8A-8I depict cycling performances of Zn—LiFePO₄ dual-ion full cells with different surface charge separator pairs.

FIGS. 9A-9C depict morphologies of Cu dendrites, deposited inside capillaries with different surface charges.

FIG. 10 depicts the SEM image of pristine Zn foil.

There are shown in the drawings arrangements that are presently discussed, it being understood, however, that the present embodiments are not limited to the precise arrangements and are instrumentalities shown. While multiple embodiments are disclosed, still other embodiments of the present disclosure will become apparent to those skilled in the art from the following detailed description, which shows and describes illustrative aspects of the disclosure. As will be realized, the invention is capable of modifications in various aspects, all without departing from the spirit and scope of the present disclosure. Accordingly, the drawings and detailed description are to be regarded as illustrative in nature and not restrictive.

### DETAILED DESCRIPTION

Embodiments described herein relate to energy storage devices (e.g., secondary batteries), and related methods of assembling the energy storage devices. An example energy storage device includes at least one electrode assembly comprised of an electrode, a counter electrode, and a separator disposed between the electrode and the counter electrode. One of the electrode and the counter electrode is a positive electrode or cathode, and the other of the electrode and the counter electrode is a negative electrode or anode. The separator includes a porous medium defining major surfaces that respectively face the electrode and the counter electrode. The first major surface of the porous medium defines a first charged region or layer. The second major surface of the porous medium defines a second, oppositely charged region or layer. The charged layer facing the anode is a negatively charged layer and the charged layer facing the cathode is a positively charged layer. The separator including the oppositely charged layers respectively defined by the major surfaces of the porous medium may also be referred to herein as a “bipolar separator.”

Each of the negatively and positively charged layers of the bipolar separator defines and/or is formed within a portion of pores extending through the separator through which metal ions can flow between the anode and the cathode. The negatively charged layer of the bipolar separator regulates the transport of metal ions from the anode toward the cathode through the pores of the separator, and the positively charged layer limits or inhibits metal dendrite growth within the pores of the separator and/or blocks local metal dendrite penetration through the pores. The bipolar design of the separators described herein facilitates enhancing uniform ionic flux by the negatively charged portion of the pores while also autonomously blocking or stopping dendrite growth and/or penetration through the pores by the localized complete concentration depletion in the positively charged portion of the pores. In this way, the issue of battery internal short-circuiting due to metal penetration through the pores of separators may be solved.

### Example Electrode Assemblies, Bipolar Separators Used Therein, and Methods of Assembling

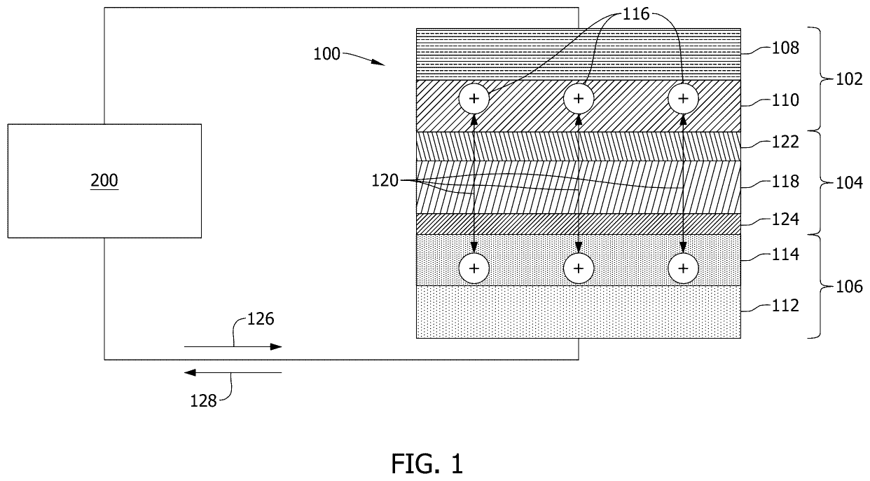

FIG. 1 is a schematic cross section of an example electrode assembly 100 suitable for use in an energy storage device. In some examples, the electrode assembly 100 is included in a secondary or rechargeable battery suitable for use in various applications including, but not limited to including, portable digital devices (e.g., mobile phones, laptop computers, electronic notebooks, digital cameras, digital video cameras, mobile game machines, and the like), automobiles (e.g., hybrid cars, electric vehicles, plug-in hybrid cars, and the like), and other energy storage systems. The electrode assembly 100 and/or components thereof may also be included in other energy storage devices, such as fuel cells, electrochemical capacitors, and the like.

The electrode assembly 100 includes a counter electrode 102, a bipolar separator 104, and an electrode 106. The electrode 106 is a negative electrode or anode in this example, and is also referred to as an anode 106. The counter electrode 102 is a positive electrode or cathode in this example, and is also referred to as a cathode 102. The cathode 102 and the anode 106 are electrically connected with an external device 200 outside the electrode assembly 100 (e.g., via respectively terminals of a secondary battery, not shown). The external device or circuit 200 facilitates charging and/or discharging the electrode assembly 100.

In the example shown in FIG. 1, the electrode assembly 100 is a planar laminate structure. In this example, when the electrode assembly 100 is incorporated in an energy storage device, the electrode assembly 100 is accommodated in a prism-shaped outer casing of the energy storage device (e.g., a prism-shaped secondary battery casing). In other examples, the electrode assembly 100 has any suitable structural configuration depending on the structure of the energy storage device. For example, the electrode assembly 100 is spirally wound in a jellyroll configuration in some examples and accommodated in a cylindrically-shaped outer casing of the energy storage device (e.g., a cylindrically-shaped secondary battery casing).

In some examples, the energy storage device includes a plurality (i.e., two or more) electrode assemblies 100. In these examples, when the energy storage device is assembled, the plurality of electrode assemblies 100 are arranged adjacent to one another and are accommodated in the outer casing of the energy storage device (e.g., a battery casing). In such examples, a cathode 102 of one of the electrode assemblies 100 is positioned next to an anode 106 of an adjacent electrode assembly 100. The cathodes 102 and anodes 106 of each electrode assembly 100 are electrically connected with the external device 200. Structures of the adjacent electrode assemblies 100 (e.g., the cathode 102 of one of the electrode assemblies 100 and the anode 106 of an adjacent electrode assembly 100) are separated by a separator (e.g., the bipolar separator 104 or another suitable type of separator). The electrode assemblies 100 in these examples may have the planar laminate structure or may be spirally wound (e.g., in a jellyroll battery configuration).

The cathode 102 includes a cathode current collector 108 and a layer or region of cathodically active material 110 disposed on the cathode current collector. The cathode current collector 108 includes any suitable electrically conducting material, such as a metal material. In various examples, the cathode current collector 108 includes a thin sheet or foil of a metal such as, for example, aluminum, carbon, chromium, cobalt, gold, iron or an iron alloy (e.g., stainless steel), nickel, NiP, palladium, platinum, rhodium, ruthenium, an alloy of silicon and nickel (e.g., nickel silicide), titanium, tungsten, a combination thereof, and/or alloys thereof. In other examples, any other material suitable for use as a cathode current collector layer is utilized. The cathodically active material 110 is shown disposed on one side of the cathode current collector 108, but in other examples the cathodically active material 110 is disposed on both sides of the cathode current collector 108. The cathodically active material 110 includes, for example, a cathodically active material selected from transition metal oxides, transition metal sulfides, transition metal nitrides, lithium-transition metal oxides, lithium-transition metal sulfides, and lithium-transition metal nitrides. Transition metal elements of these transition metal oxides, transition metal sulfides, and transition metal nitrides may include metal elements having a d-shell or f-shell, such as Scandium (Sc), Yttrium (Y), lanthanoids, actinoids, Titanium (Ti), Zirconium (Zr), Hafnium (Hf), Vanadium (V), Niobium (Nb), Tantalum (Ta), Chromium (Cr), Molybdenum (Mo), Tungsten (W), Manganese (Mn), Technetium (Tc), Rhenium (Re), Iron (Fe), Ruthenium (Ru), Osmium (Os), Cobalt (Co), Rhodium (Rh), Iridium (Ir), Nickel (Ni), Lead (Pb), Platinum (Pt), Copper (Cu), Silver (Ag), and Gold (Au). The cathodically active material 110 may also include LiCoO₂, LiNi_{0.5}Mn_{1.5}O₄, Li(NiₓCo_{y}Al_{z})O₂, LiFePO₄, Li₂MnO₄, V₂O₅, molybdenum oxysulfides, phosphates, silicates, vanadates, sulfur, sulfur compounds, oxygen (air), Li(NiₓMn_{y}Co₂)O₂, and combinations of two or more thereof.

The anode 106 includes an anode current collector 112 and a layer or region of anodically active material 114 disposed on the anode current collector. The anode current collector 112 may include any suitable electrically conducting material, such as a metal material. In various examples, the anode current collector 112 includes a thin sheet or foil of conductive material such as copper, carbon, nickel, iron or an iron alloy (e.g., stainless steel), cobalt, titanium, and tungsten, a combination thereof, and/or alloys thereof. Any other material suitable for use as an anode current collector layer may be utilized. The anodically active material 114 is shown disposed on one side of the anode current collector 112, but in other examples the anode active material 114 is disposed on both sides of the anode current collector 112. The anodically active material 114 includes, for example, an anodically active material selected from alkali metals such as lithium (Li), sodium (Na), or potassium (K), and alkaline earth metals such as magnesium (Mg). The anodically active material 114 may also include silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd), alloys or intermetallic compounds thereof, optionally with other elements, oxides, carbides, nitrides, sulfides, phosphides, selenides, and tellurides thereof and their mixtures or composites, lithium titanate, lithium manganate, lithium aluminate, lithium-containing titanium oxide, lithium transition metal oxide, ZnCo₂O₄, particles of graphite and carbon, and combinations of two or more thereof.

The separator 104 is positioned between the cathode 102 and the anode 106 to prevent direct electrical contact between the electrodes. The separator 104 is porous and is impregnated with an electrolyte that enables charge carrier ions 116 to flow through the separator 104 and move between the cathode 102 and the anode 106. In some examples, the charge carrier ions 116 are metal ions, such as lithium ions, zinc ions, sodium ions, potassium ions, calcium ions, magnesium ions, or combinations of two or more thereof. In certain examples, the charge carrier ions 116 are lithium ions, zinc ions, or a combination thereof.

Any suitable electrolyte may be used, including aqueous (or water-based) electrolytes and non-aqueous electrolytes. In some examples, the electrolyte (aqueous or non-aqueous) is a liquid or gel. The liquid electrolyte is prepared by dissolving a metal salt (e.g., a lithium salt, a zinc salt, a sodium salt, a potassium salt, a calcium salt, or a magnesium salt) in a liquid solvent (aqueous or non-aqueous). By dissolving the metal salt in the liquid solvent, the charge carrier ions 116 and anions are generated in the liquid electrolyte. In some examples, the aqueous liquid solvent is a concentrated saline solution. Non-limiting examples of non-aqueous solvents include esters, ethers, nitriles, amides, halogen (e.g., fluoride) substituted products thereof, and combinations of two or more thereof. The gel electrolyte includes a metal salt and a matrix polymer, and optionally a solvent (e.g., non-aqueous solvent). In some examples, the matrix polymer is a polymer material that absorbs and gels the non-aqueous solvent. Non-limiting examples of a polymer material that is used as the matrix polymer include fluororesins, acrylic resins, and polyether resins.

In various examples, any anion suitable for use in an aqueous or non-aqueous electrolyte is included in the metal salt used to prepare the electrolyte. Non-limiting examples thereof include anions of SO₄—, BF₄—, ClO₄—, PF₆—, CF₃SO₃—, CF₃CO₂—, anions of imides (e.g., N(SO₂CF₃)₂—), and anions of oxalate complexes (e.g., bisoxalateborate anion, difluorooxalateborate anion (BF₂(C₂O₄)—), PF₄(C₂O₄)— anion, and PF₂(C₂O₄)²⁻). The electrolyte may contain one or more (e.g., two or more) kinds of anions, including combinations of two or more of the anions described.

The separator 104 includes a porous medium 118 provided with pores 120 through which the charge carrier ions 116 flow. Any porous material (e.g., microporous or macroporous material) suitable for use as a separator may be utilized for the porous medium 118. A “microporous” medium 118 may contain pores 120 with diameters less than about 2 nanometers. A “macroporous” medium 118 may contain pores 120 with diameters greater than about 50 nanometers. In some examples, the porous medium 118 may be made of a polyolefin material, such as polyethylene or polypropylene for example. In other examples, the porous medium 118 includes another polymer material such as a polyamide resin or cellulose. In various examples, the porous medium 118 is any suitable porous sheet (e.g., a microporous thin film, woven cloth, nonwoven cloth, and the like) having ion permeability and insulating properties that enable the separator 104 to function as described herein.

In some examples, the porous medium 118 is coated with an additional material, for example, a ceramic coating. For example, the porous medium 118 may be coated with alumina (Al₂O₃) particles for improved high-temperature safety. In some examples, the porous medium 118 is made of a ceramic-coated polyethylene material. In some examples, the porous medium 118 includes additional or alternative modifications to improve or alter the functionality thereof. For example, the porous medium 118 in some examples is plasma-treated to improve wettability of the porous medium 118 with the liquid electrolyte.

The separator 104 also includes oppositely charged regions or layers 122 and 124. The oppositely charged layers 122 and 124 are respectively located at, or defined by, the opposing major surfaces of the porous medium 118 that face the cathode 102 and the anode 106. The oppositely charged layers 122, 124 may be respectively disposed or formed on one of the major surfaces of the porous medium 118, and/or define one of the major surfaces of the porous medium 118 that respectively faces the cathode 102 and the anode 106. The oppositely charged layers 122 and 124 define and/or are formed within a portion of the pores 120 on the opposing surfaces of the porous medium 118. The first charged layer 122 that faces the cathode 102 is a positively charged layer 122 and the second charged layer 124 that faces the anode 106 is a negatively charged layer 124. In some examples, the first charged layer 122 includes one or more (e.g., two or more than two) positively charged layers. Additionally or alternatively, in some examples, the second charged layer 124 includes one or more (e.g., two or more than two) negatively charged layers.

FIG. 1 depicts the separator 104 as including an uncharged region or layer of the porous medium 118 between the oppositely charged layers 122 and 124. This is by way of example and for convenience of illustration and description. In some examples, the oppositely charged layers 122 and 124 are stacked adjacent one another and the porous medium 118 is formed entirely of the charged layers 122, 124. Stated another way, in some examples, the uncharged region of the porous medium 118 between the oppositely charged layers 122 and 124 has a thickness of zero. In these examples, the charged layers 122 and 124 may have the same thickness or a different thickness. In other examples, the porous medium 118 includes an uncharged region between the oppositely charged layer 122 and 124. In these examples, the charged layers 122 and 124 and the uncharged region of the porous medium 118 may have the same thickness or a different thickness. The uncharged region of the porous medium 118, when included, may include one or more (e.g., two or more) layers. In some examples, the uncharged region of the porous medium 118 includes one or more layers, at least one of which is modified to improve or alter the functionality thereof, including, for example, the modifications described above.

In some examples, the charged layers 122 and 124 are formed by immersing the porous medium 118 in a suitably charged polyelectrolyte solution. For example, the positively charged layer 122 is formed by immersing the porous medium 118 in a positively charged polyelectrolyte (or polycation) solution and the negatively charged layer 124 is formed by immersing the porous medium 118 in a negatively charged polyelectrolyte (or polyanion) solution. In some examples, the positively charged layer 122 and/or the negatively charged layer 124 is formed by a successive (layer-by-layer) immersing process in which the porous medium 118 is first immersed in an oppositely charged polyelectrolyte and subsequently immersed in the suitably charged polyelectrolyte so that the charged layer 122 and/or 124 can be more easily attached. For example, the porous medium 118 is immersed initially in a polycation solution to form a positively charged layer 122 on each major surface of the porous medium 118 and subsequently immersed in a polyanion solution to form a negatively charged layer 124 on one of the surfaces. Alternatively, the porous medium 118 is immersed initially in a polyanion solution to form a negatively charged layer 124 on each major surface of the porous medium 118 and subsequently immersed in a polycation solution to form a positively charged layer 122 on one of the surfaces. In other examples, any suitable method is utilized to form the charged layers 122 and 124 on the porous medium 118 and enable the separator 104 to function as described herein.

The charged electrolyte solutions used to form the charged layers 122 and 124 include any suitable charged polymer. The positively charged electrolyte or polycation solution includes any suitable positively charged polymer, including, for example, poly(diallyldimethylammonium chloride), poly(N-methyl-4-vinylpyridinium iodide), poly(allylamine hydrochloride), poly(butyl acrylate-co-N-methyl-4-vinylpyridinium iodide), poly(butadiene-co-N-methyl-4-vinnylpyridinium) iodide, poly(styrene-co-4-vinylpyridine), poly(ethyl acrylate-co-4-vinylpyridine), polyaniline-based polymers, polypyrrole-base polymers, or other suitable polycations. The negatively charged polyelectrolyte or polyanion solution includes any suitable negatively charged polymer including, for example, poly(styrenesulfonate), poly(sodium styrene sulfonate), poly(acrylic acid) sodium salt, poly(acrylic acid)-co-polymers, (poly(styrene-co-sodium styrenesulfonate), poly(sulfone-co-sodium sulfonate), poly(ethy acrylate-co-sodium acrylate), poly(butadiene-co-lithium methacrylate), poly(ethylene-co-sodium methacrylate), poly(ethylene-co-magnesium methacrylate), zinc-sulfonated ethylene-propylen-terpolymer, carboxymethyl cellulose sodium salt, or other suitable polyanions. In certain examples, the positively charged electrolyte includes poly(diallyldimethylammonium chloride) and the negatively charged electrolyte includes poly(styrenesulfonate).

In some examples, the porous medium 118 is made directly from the positive layer 122 and the negative layer 124. Stated another way, the porous medium 118 is built by directly forming stacked, porous layers of the positive layer 122 and the negative layer 124. For example, the positive layer 122 and negative layer 124 are made directly from positively charged polymers and negatively charged polymers, respectively, using suitable production techniques such as electrospinning. In some such examples, the charged polymers include, but are not limited to including, polymers suitable for use for anion-exchange membranes and cation-exchange membranes. In an example electrospinning process, positively charged porous layer(s) and negatively charged porous layer(s) are drawn and then hot/warm rolled by a roller mill into a single piece. In these examples, the hot/warm rolling is controlled to preserve the porosity and limit or prevent fusing the polymers into a non-porous piece. Here again, in some examples, the first charged layer 122 includes one or more (e.g., two or more than two) positively charged layers and/or the second charged layer 124 includes one or more (e.g., two or more than two) negatively charged layers. In some examples, the porous medium 118 is entirely formed of the oppositely charged layers 122, 124. Alternatively, the porous medium 118 is formed directly from the oppositely charged layers 122, 124, and an additional uncharged layer of the porous medium 118 is included between the positively charged layer 122 and the negatively charged layer 124. For example, a thin woven fabric is included in the porous medium 118 between the layers 122, 124 to increase the mechanical strength of the final bipolar separator 104.

In an example method of assembling an energy storage device (e.g., a secondary battery) that includes the electrode assembly 100, the cathode 102 and the anode 106 are each prepared from thin metal sheets or foils used as the cathode current collector 108 and the anode current collector 112. Suitable materials for the cathode current collector 108 and the anode current collector 112 are described above. The cathodically active material 110 and the anodically active material 114 are respectively applied to the cathode current collector 108 and the anode current collector 112. In some examples, the active materials 110, 114 are applied to the respective current collector 108, 112 as a slurry of the active material (described above), a binder (e.g., polyvinylidene fluoride, PVDF), a thickener, a conductive agent (e.g., acetylene black and/or conductive carbon), and a solvent (e.g., N-methyl-2-pyrrolidone, NMP), and film-casted or dried and rolled on the current collector to a desired thickness to form the cathode 102 and anode 106. The electrolyte is also prepared, for example, as a liquid or gel, aqueous or non-aqueous, as described above. The bipolar separator 104 is prepared as described above, by forming the charged layers 122 and 124 that respectively define major surfaces of the porous medium 118. In some examples, the positively charged layer 122 is formed by immersing the porous medium 118 in a positively charged electrolyte solution and the negatively charged layer 124 is formed by immersing the porous medium 118 in a negatively charged polyelectrolyte solution (e.g., by a layer-by-layer immersing process). In other examples, the porous medium 118 is made or built directly from the stacked charged layers 122 and 124, that is, the positively and negatively charged layers 122, 124 are formed directly (e.g., by electrospinning followed by rolling to produce positive and negative porous layers) and then stacked. The separator 104 has the negatively charged layer or layers 124 on one major surface of the porous medium 118 and the positively charged layer or layers 122 on the other major surface of the porous medium 118. The layers 122, 124 may be stacked adjacent to one another, or the separator 104 may also include one or more uncharged (and optionally modified) layers of the porous medium 118 between the oppositely charged layers 122, 124.

The example assembly method continues with the cathode 102 and the anode 106 being positioned relative to each other, with the bipolar separator 104 positioned therebetween such that the positively charged layer(s) 122 faces the cathode 102 and the negatively charged layer(s) 124 faces the anode 106. The electrode assembly 100 is then positioned within an outer casing (e.g., a package made from an aluminum laminate sheet). The electrolyte is injected into the outer casing and impregnates the separator 104 of the electrode assembly 100. The cathode 102 and the anode 106 are respectively connected to a terminal of the energy storage device, the terminals extending from the outer casing of the energy storage device. In some examples, multiple electrode assemblies 100 are positioned within the outer casing and stacked with a separator (e.g., the separator 104) positioned between adjacent electrode assemblies 100. In these examples, the electrolyte injected into the outer case impregnates each separator 104. In some examples, the electrode assembly 100, or multiple electrode assemblies 100, are spirally wound prior to being positioned within the outer casing. The electrode assembly 100, or multiple electrode assemblies 100, is connected to an external device (e.g., the external device 200) via the terminals of the energy storage device.

In operation of the energy storage device (e.g., a secondary battery) including one or more of the electrode assemblies 100, each electrode assembly 100 is cycled between charging and discharging operations by an electric potential selectively applied across the cathode 102 and the anode 106. During charging, electrical current is supplied to the anode 106 in a direction indicated by arrow 126, and the charge carrier ions 116 move from the cathode 102 toward the anode 106 through the pores 120 of the separator 104. During discharging, electrical current exits the anode 106 towards the external device 200 in a direction indicated by arrow 128, and the charge carrier ions 116 move from the anode 106 toward the cathode 102 through the pores 120 of the separator 104. The negatively charged layer 124 that faces the anode 106 enables a uniform flux of the metal ions through the pores 120 during discharging and the positively charged layer 122 starve-stops local metal dendrite growths that may penetrate the negatively charged portion of the pores 120 by a localized complete concentration depletion mechanism. The bipolar separator 104 thus includes the negatively charged layer 124 to regulate the transport of metal ions and the positively charged layer 122 that facilitates autonomously blocking or stopping metal dendrite growth to extend battery life that may otherwise be shortened by internal short-circuiting due to metal penetration through the pores 120 of the separator 104.

### Experimental Results

Described herein are bipolar separators that include positive and negative charges separately fixed on the pore walls. This bipolar design induces self-adaptive electrokinetic effects in liquid-electrolyte-wetted separator pores that can autonomously stop metal dendrite growth and/or penetration, thereby enhancing the fast charging capability of an energy storage device (e.g., a secondary battery). Rational optimizations of the bipolar separator and the electrolytes have the potential to stabilize the separator-electrode interface and enable high-loading, fast-charging, yet long cycle-life metal batteries (e.g., lithium metal batteries and zinc metal batteries) that can meet practical but challenging goals. Demonstrated herein are experiments that reveal improved dendrite growth dynamics in lithium metal and zinc metal batteries that implement bipolar separators according to the present disclosure.

### A. Bipolar Separators Used in Lithium-Ion Batteries

Lithium metal batteries (LMBs) can significantly increase the energy density of current lithium-ion batteries (LIBs) by replacing the bulky graphite porous electrode with a thin lithium metal anode in situ formed on the copper current collector. However, charging LMBs at high current densities (≥6 mA cm⁻²) has been plagued by dendrite penetration through separators. Most conventional charging current densities are around 0.5 mA cm⁻², with only a few instances current densities higher than 1 mA cm⁻², thereby achieving cycle life (80% initial capacity) of about 100 cycles.

In contrast, the present disclosure achieves the parameters shown in Table 1 below.

TABLE 1
Performance parameters for the present bipolar separators.

| | | Anode | | | |
|---|---|---|---|---|---|
| Cathode | | Li/Cathode | Current Density (C-rate) | | Cyclability |
| Loading | Capacity | Ratio | Charging | Discharging | Loading |
| 5 mAh cm⁻² | ~220 mAh cm⁻² | 0-0.2 | ≥10 mA cm⁻² | ~1 mA cm⁻² | 100 cycles to |
| | | | (2 C) | | 80% |
| 5 mAh cm⁻² | ~220 mAh cm⁻² | 0-0.2 | 2 mA cm⁻² | ~1 mA cm⁻² | 1000 cycles to |
| | | | (0.4 C) | | 80% |

While the chemistry of the electrolytes and the solid-electrolyte interphase (SEI) is critically important, the fast-charging performance of LMBs is dominated by transport kinetics toward the interface through the separator pores. Based on experimental and theoretical discoveries, bipolar separators can be made to achieve the performance listed in Table 1.

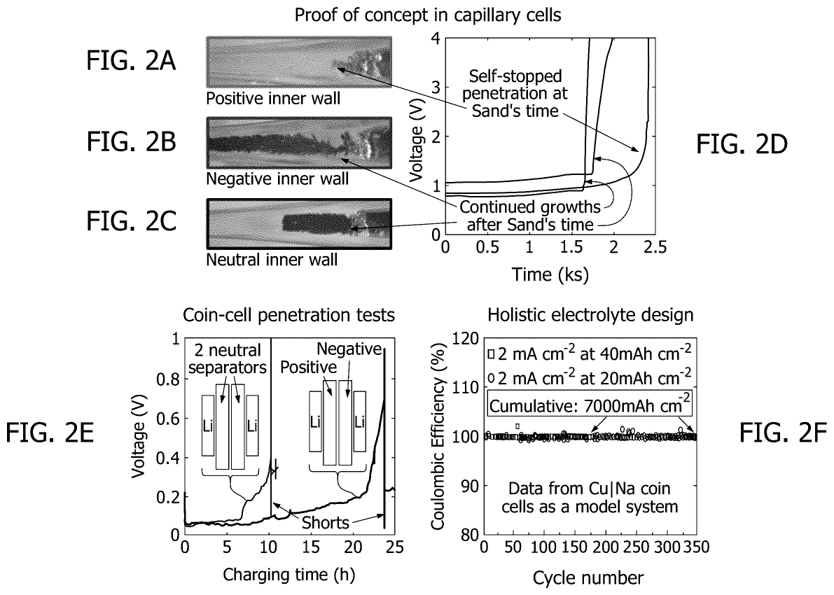

Metal dendrite penetration is frequently observed in LMBs that include conventional, commercially available separators. Commercial battery separators are inert porous films made of neutral materials (FIG. 2A), such as polyethylene (PE), polypropylene (PP), sometimes coated with alumina (Al₂O₃) particles for improved high-temperature safety. Polymer electrolytes that have fixed background charges have also been proposed, but only with negative charges. Yet the resulted transport kinetics are slower than the liquid-electrolyte-wetted porous separators at low temperatures. Recent innovations in battery separators for LMBs only utilized negatively charged functional groups. There is no research or product reporting or exploiting the concept of bipolar separators to enable fast-charging LMBs as disclosed herein.

It is well-known that an insulating medium with fixed negative background charges can help stabilize the Li metal interface at relatively low current densities. However, possible engineering defects and higher charging current densities promote the metal deposits to “squeeze” into a few isolated pores. Once this happens, the Li⁺ ion flux through the liquid phase preferentially focuses on the metal tip, yielding a local current density that easily exceeds the system-specific limiting current density. This local overlimiting current density can trigger fast-advancing lithium dendrites to short-circuit the battery through an isolated channel.

However, while such localized overlimiting behaviors can be exploited to stop dendritic penetration, they have not been previously demonstrated. If metal deposits find a localized path to invade through the pores of the negatively charged region, incoming Li⁺ flux will inevitably focus on that path, leading to a faster growth to reach the positive region. Since the local current density easily exceeds the limiting current density, ions in the positively charged pores will be quickly and completely depleted. As such, the dendritic growth is starved to a complete stop autonomously. This is experimentally visualized in FIG. 2A.

In comparison with LMBs that include conventional separators, LMBs that include bipolar separators (e.g., the separator 104) according to the present disclosure facilitate preventing local metal penetration through the pores of the separator even at current densities higher than 6 mA cm⁻², while also facilitating uniform Lit ion flux through the pores. In particular, the negatively charged regions of the pores of the bipolar separator ensure uniform Li⁺ ion flux and, on the occurrence of a local metal penetration, the positively charged regions of the pores of the bipolar separator can stop the penetration by the self-adapted strong concentration depletion.

Referring to FIGS. 2A-2F, demonstrated herein are operando experiments performed with charged glass capillaries. FIGS. 2A-2C depict metal penetration in capillary cells. Self-stopped metal penetration is observed in a positively charged capillary (FIG. 2A). Continued growths are observed in negative capillaries (FIG. 2B) and untreated capillaries (FIG. 2C). FIG. 2D illustrates corresponding voltage responses in the capillary cells of FIGS. 2A-2C. FIG. 2E illustrates penetration tests in coin cells that revealed that the bipolar separator extended the penetration capacity by ˜140% at the current density of 10 mA cm⁻². FIG. 2F illustrates that ideally stable Na metal half cells demonstrated super long cycle-life.

As can be seen in FIG. 2A, when an overlimiting current density was applied (mimicking local penetration), the growth in the positive capillary stopped by itself at Sand's time, due to the complete depletion of Li⁺ ions. In contrast, the growths in both the negative (FIG. 2B) and neutral (FIG. 2C) capillaries continued to form the familiar fractal dendrites. Penetration tests in coin cells with the bipolar configuration (FIG. 2E) revealed that the penetration capacity extended by ˜140% more, at 10 mA cm⁻². The baseline electrolyte used was 0.5 M lithium bis(trifluoromethane-sulphonyl) imide (LiTFSI) in dimethoxyethane (DME). The electrolyte and the separator may be optimized, and ideally stable Na-metal batteries (FIG. 2F) may be exploited to facilitate investigation toward LMBs.

B. Bipolar Separators used in Zinc-Ion Batteries

### Overview

Zinc metal anodes are attracting much attention to enable more economical and sustainable energy storage devices. However, like other metal anodes, dendritic growths and penetrations of porous separators are still challenging to eliminate. Introducing negative surface charges on the pore walls of separators have been exploited to enforce a uniform incoming Li-ion flux toward more uniform electrodeposition, but penetrations induced by localized high current densities still remain in available systems.

As described herein, a bipolar separator that exploits the distinct electrokinetic effects of the negative and the positive surface charges facilitates blocking dendritic growth and/or penetration through the pores of the separator. Bipolar separators according to the present disclosure were investigated in zinc (Zn) metal batteries. The surface charge effects on Zn dendrite growths were first verified in transparent capillary cells via operando video microscopy. By stacking the positively charged separator over the negatively charged separator as a proof-of-concept, the system offers preemptively a uniform Li-ion flux through the negative layer yet starve-stops local metal growths that already penetrated the negative layer autonomously. Chronopotentiometry experiments with the symmetric cells reveal extended short-circuit time compared to control cells. Galvanostatic cycle-life experiments of full cells with the bipolar separator showed excellent cycle life of 5,000 cycles at the rate of 10 C, without signs of metal penetration.

### Introduction

Here, the effects of different surface charges on the growth dynamics of Zn electrodeposition by are first investigated by operando video microscopy in transparent glass capillary cells. The observation of the autonomous stopping of Zn dendrite growth in the positively charged glass capillary suggests a starve-stop mechanism due to the complete concentration depletion. The bipolar design of separators, in which uniform ionic flux can be enhanced by the negatively charged pores while the localized complete concentration depletion in positively charged pores can autonomously stop the dendrite penetration, are proposed. Zn metal symmetric cells and Zn—LiFePO₄ dual-ion full cells were fabricated to assess the bipolar separator. The demonstrated results, that bipolar separators can indeed extend the short-circuiting time in one-way chronopotentiometry experiments and can enable cycling without penetration at high currents, prove the effectiveness of this system.

### Results

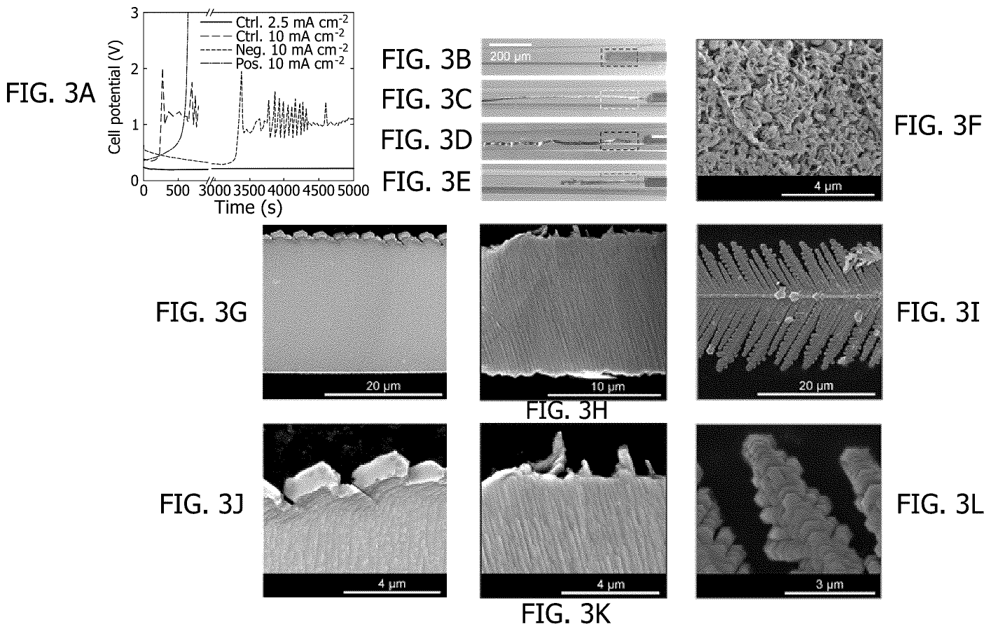

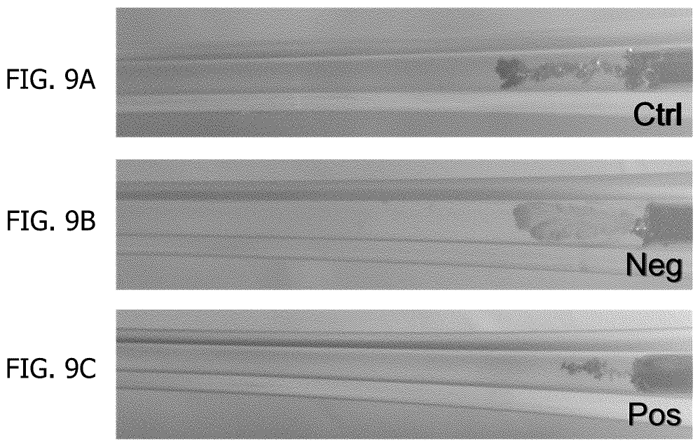

Referring to FIGS. 3A-3L and 9A-9C, the electroosmotic effects due to pore-wall changes on the morphology of Zn deposits are demonstrated. FIG. 3A depicts chronopotentiometry curves for capillary cells with different surface charges. FIGS. 3B-3E depict morphologies of Zn dendrites, deposited inside capillaries with different surface charges and current densities. FIGS. 3F-3L depict SEM images of Zn dendrites, collected from capillaries after the deposition. FIGS. 3B and 3F relate to underlimiting current (2.5 mA cm⁻²) in a control cell. FIGS. 3C, 3G, and 3J relate to overlimiting current (10 mA cm⁻²) in the control cell. FIGS. 3D, 3H, and 3K relate to overlimiting current (10 mA cm⁻²) in a negatively charged cell. FIGS. 3E, 3I, and 3L relate to overlimiting current (10 mA cm⁻²) in a positively charged cell. The electrolyte used was 0.1 M Zinc trifluoromethanesulfonate (Zn(OTf)₂) aqueous solution. FIGS. 9A-9C depict morphologies of Cu dendrites, deposited inside capillaries without treatment (FIG. 9A), negatively charged capillaries (FIG. 9B), and positively charged capillaries (FIG. 9C).

Transparent capillary cells allow the operando observation of the metal deposition under various electrochemical polarization. For this study, capillary cells with charges deposited on the inner walls were used to observe the electrokinetic effects on the morphology of metal deposits. Symmetrical Zn metal cells were assembled within a glass capillary with 0.1 M Zinc trifluoromethanesulfonate (Zn(OTf)₂) solution as an electrolyte (FIGS. 3A-3L). For the underlimiting current case in the untreated capillary, the deposition showed a typical mossy growth (FIGS. 3B and 3F), but unlike local protrusions of individual whiskers observed in alkali metals, the deposits tend to fill the channel with very low porosity (as shown in FIGS. 3B and 3F). The chronopotentiometry curve for the underlimiting condition showed typical current behavior of a flat current plateau without any peaks (FIG. 3A). For the case of overlimiting current in the untreated capillary, Zn grew into a single straight needle (FIGS. 3C, 3G, and 3J), in stark contrast to the branched dendritic growths found in alkali metals or copper electrodepositions (see FIGS. 9A-9C). The chronopotentiometry curve for this case still showed a typical transport-limited response, where the transient potential tended to diverge at the Sand's time, marking the onset of needle-like growth.

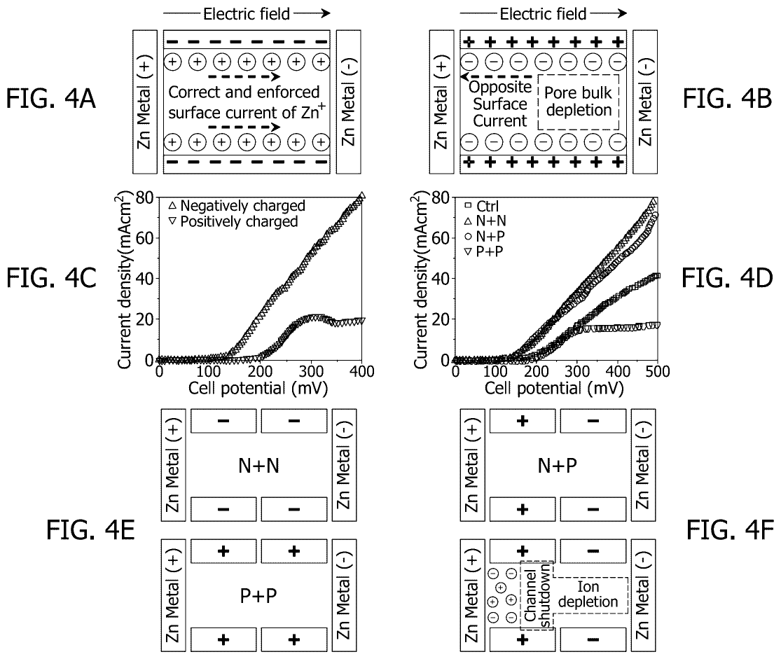

With the negative surface charge, however, the growth looked like a flexible belt with wrinkles and appeared to grow near the wall (FIGS. 3D and 3H). This is expected as during the transport-limited growth, cations are only supplied from the electrical double layers (EDLs) near the negatively charged walls, while those in the bulk are completely depleted at transport limitation. The structure appears to be a well-defined crystal structure (FIG. 3H) but with notable defects at the edge (FIG. 3K). The chronopotentiometry curve for the negatively charged case showed a similar sudden rise of potential, similar to that from the untreated capillary, but with a much-delayed depletion time, suggesting the contribution from the surface conduction via the EDLs (see FIG. 4A). For the positively charged capillary, the potential spike was not followed by a fluctuating plateau and did not induce continued transport-limited growth. Instead, it quickly diverged toward the potential limit of the potentiostat, resulting in an autonomous stopping of the growth. As depicted in FIG. 4B, when transport limitation is reached, the positively charged surface no longer has the excess Zn ions in the EDL structure to sustain the current. This autonomous channel shutdown due to transport dynamics may be exploited for the suppression of dendrite penetration through practical porous separators, where the electrokinetic effects could be more significant due to the much smaller pores.

Referring to FIGS. 4A-4F, the electroosmotic effects in charged porous separators are demonstrated. FIGS. 4A and 4B depict ion transport phenomena inside negative pores (FIG. 4A) and positive pores (FIG. 4B). FIGS. 4C and 4D depict linear sweep voltammetry results inside split cells tested with different surface-charged separators and 0.1 M Zn(OTf)₂ aqueous electrolyte. FIG. 4C depicts results for single layer separators and FIG. 4D depicts results for separators having two layers. The scan rate was 5 mV s⁻¹. FIGS. 4E and 4F depict the schematic diagram for two layer separator systems. FIG. 4E depicts two negative layers and two positive layer separator systems. FIG. 4F depicts the bipolar separator system and the autonomous shutdown mechanism.

Following the method by Han et al., cited supra, ceramic-coated porous polyethylene (PE) membranes were treated to have either positive or negative surface charges on the pore walls. By staking the negative and positive separators together, with the negative layer facing the working electrode, the fixed negative surface charge can help enforce a uniform cation flux for more uniform and more stable electrodeposition. If local penetration accidentally occurs and penetrates through the negative layer to reach into the positive pores the highly focused current will lead to the complete concentration depletion in those positively charged pores and stop the penetration as observed in the positive glass capillary.

Linear sweep voltammetry (LSV) was first used to test the effect of surface charges on the separators inside symmetrical Zn metal cells with 0.1 M Zn(OTf)₂ electrolyte. For the single-layer separator cells, both the positively and negatively charged samples initially showed a similar LSV curve at low potentials, but they exhibited a clear difference from 150 mV (FIG. 4C). The positive separator showed a plateau at 20 mA cm⁻² suggesting a limiting current density caused by transport limitation, while the negative case showed no plateau, meaning that the overlimiting current was maintained by the surface conduction mechanism. For a fair comparison with the stacked negative-positive bipolar separator, the two-layer positive separator and two-layer negative separator were tested, which showed virtually the same trends with their corresponding results for the monolayer cases (FIG. 4D). Note that the control separator with no polyelectrolyte treatment was still plasma-treated for wettability, yielding minor negative charges to the pores. For the bipolar separator, the curve was very close to the two-layer negative case. This is because in both systems, the diffusion layer starts from the metal surface into negative pores, and the effect of positive charges would only occur when the deposition fully penetrates the negative layer, as will be discussed further below. This still suggests that even when the negative and positive separators are stacked together, the cell will still benefit from the improved ion transport by the negative surface charges.

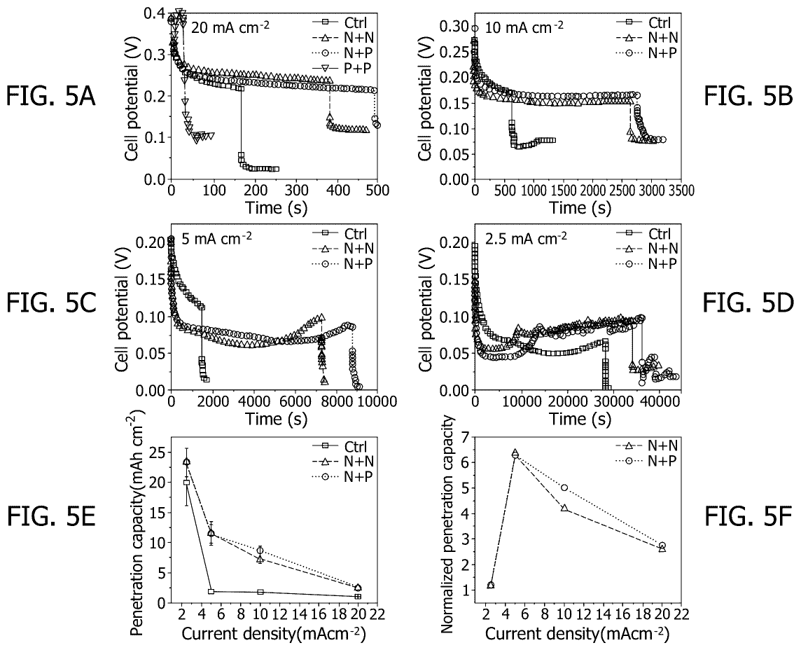

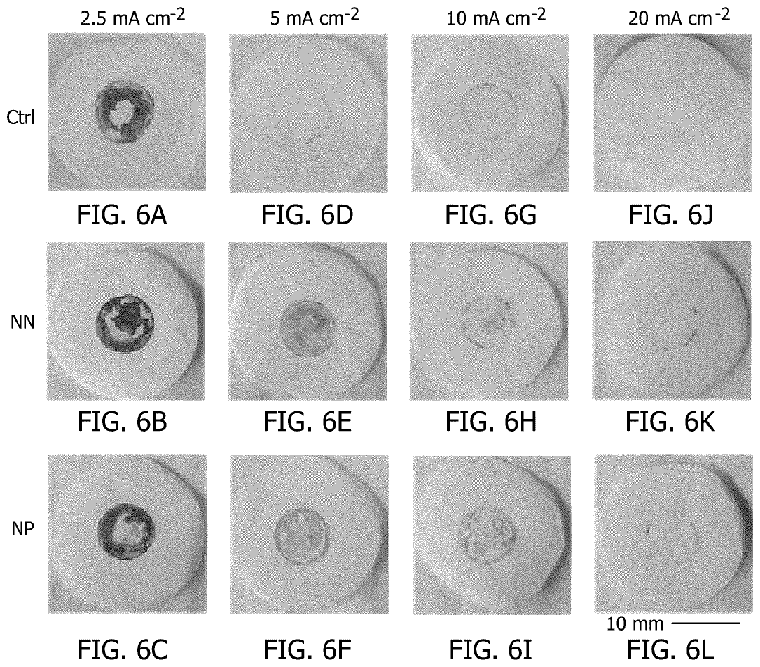

Referring to FIGS. 5A-5F and FIGS. 6A-6L, results of experiments with a bipolar separator in Zn symmetric cells are demonstrated. FIGS. 5A-5D depict chronopotentiometry curves for the Zn symmetric cells with different surface-charged separator pairs. FIG. 5E depicts penetration capacity of the Zn symmetric cells. The error bar denotes the standard deviations. FIG. 5F depicts normalized penetration capacity of the charged separator pair cells, compared with the control Zn symmetric cells. FIGS. 6A-6L depict post-mortem images of the penetrated separators. The sides shown in FIGS. 6A-6L were facing the counter electrode during the polarization.

To test the hypothesis that both the negative and positive surface charges can be exploited for the extended cycle life of metal anodes, chronopotentiometry experiments were performed with the same type of Zn symmetric cells used above (FIGS. 5A-5F). For all current densities tested (from 2.5 mA cm⁻² to 20 mA cm⁻²), the bipolar positive-negative (PN) separator and the two-layer negative-negative (NN) separator showed significantly extended short circuit times compared to control cells (FIGS. 5A-5E). For 20 mA cm⁻², the two-layer positive-positive (PP) separator was also tested, which showed a much short circuit time, even shorter than the control cells with untreated separators. While the pure positive separators worsen the cell life significantly, the bipolar separator consistently showed a cell life equal to or slightly better than the pure negative separators at all current densities.

The penetration capacities enabled by charged separators at different current densities, normalized to that of control cells, are shown in FIG. 5F to quantitatively reveal the improvements. At the current density of 2.5 mA cm⁻², the improvement was almost negligible. Interestingly, the most significant improvements were achieved at 5 mA cm⁻² and 10 mAcm⁻², which are still under-limiting current densities, i.e., lower than 16 mA cm⁻² (FIG. 4D). At an overlimiting current of 20 mA cm⁻², the improvement becomes significantly less. It is worth mentioning that the effect of surface charge should be most significant at overlimiting current densities that can trigger diffusion limitation and concentration depletion, yet the results at 20 mA cm⁻² seem to contradict the theory. However, the discrepancy may be attributed to the heterogeneous current distribution during the metal penetration through the porous separator.

The post-mortem images of the separators collected from the failed cells demonstrate the heterogeneous deposition, revealed by the dark regions that are concentrated near the edge of the Zn electrode, especially in the cases of high current densities and with untreated separators (FIGS. 6D, 6G, and 6J-L). For the lower current density of 2.5 mA cm⁻² (FIGS. 6A-C), the penetration regions were distributed more evenly over the electrode, and the differences between the control and treated samples were not very significant. In contrast, at 5 mA cm⁻² and 10 mA cm⁻², which are still under-limiting current cases, there was a clear difference between the treated separators and untreated separators. The negative-negative (NN) (FIG. 6E) and bipolar (PN) systems (FIG. 6F) reveal a much more homogeneous deposition, occupying more electrode surfaces compared to the control sample (FIG. 6D). Note that the total amount of deposition is higher for the cells with treated separators due to the longer charging time before cell failures. For the overlimiting current cases (20 mA cm⁻², FIGS. 6J-L), all depositions were focused near the edge of the electrode, suggesting that the pore-wall charges can no longer regulate the current distribution by surface conduction through the EDLs.

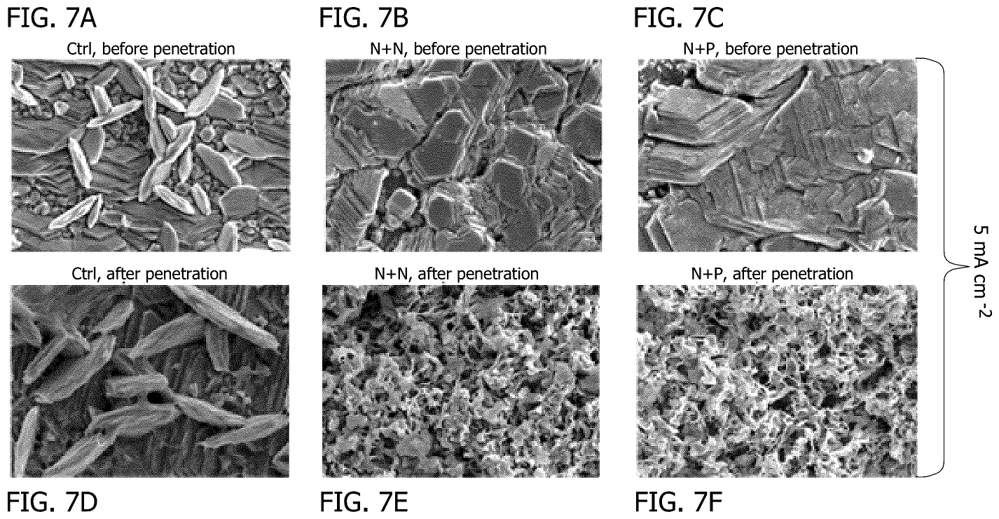

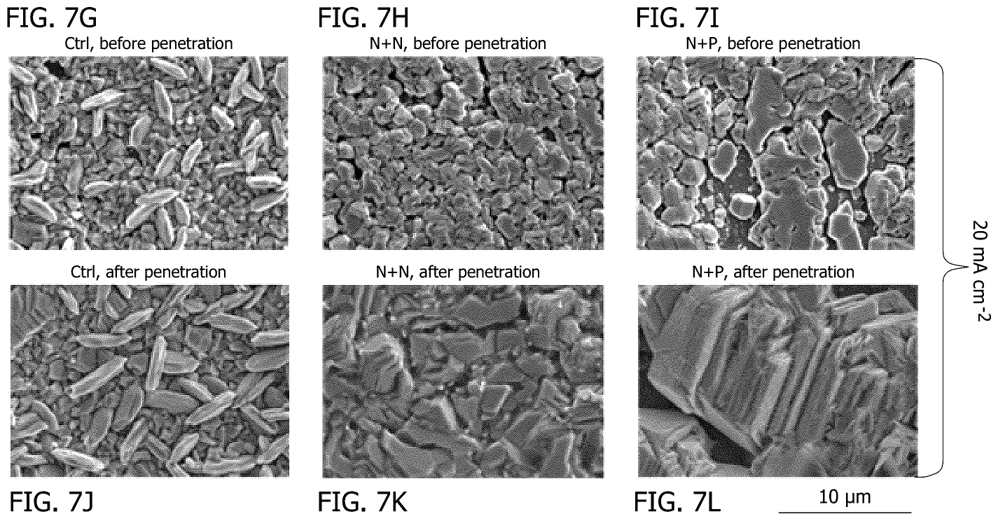

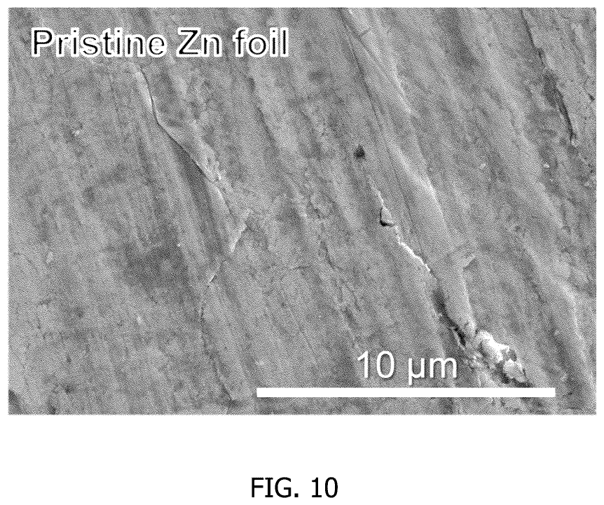

Referring to FIGS. 7A-7L, different morphologies of Zn deposition on the working electrode are depicted with the samples collected before the cell penetration and after the cell penetration. FIGS. 7A-7F depict deposition with the current density of 5 mA cm⁻². FIGS. 7G-7L depict deposition with the current density of 20 mA cm⁻². For before-penetration samples, the same amount of areal capacity (0.5 mAh cm⁻²) was charged before the sample was collected. The SEM image of the pristine Zn surface is shown in FIG. 10.

FIGS. 7A-7L show the SEM images of the Zn working electrode after the deposition, which provide more insight into the reason for the highest improvement observed with an underlimiting current density (5 mA cm⁻²). Here, the images that were taken after a certain amount of capacity has been charged (0.5 mAh cm⁻²) are compared with the images taken after the short circuit. The control samples showed similar morphology regardless of the current density, a mixture of small boulders and layers with spindle-shaped deposits which suggests a mixed activation and diffusion control. Especially the spindle-shaped deposits appeared to grow perpendicular to the surface and were only found on control samples, suggesting that the process is more toward diffusion-controlled and more heterogeneous. In stark contrast, both the NN separator and PN separator resulted in a layer-like deposition at 5 mA cm⁻² before the penetration (FIGS. 7B and 7C), which can be attributed to the activation-controlled process. Interestingly, for the 5 mA cm⁻², the layer-like deposition led to a mossy-type growth in the later stage (FIGS. 7E and 7F), which is found for the lower end of the activation control region in the morphology diagram. This suggests that the current distribution was effectively homogenized by surface conduction and minimized the chances of whisker protrusion or dendrite formation.

Compared to the growths found in charged separators at 5 mA cm⁻², no mossy growths were discovered with charged separators at 20 mA cm⁻². They, instead, showed a diffusion-controlled small boulder-type structure in the early stages of deposition (FIGS. 7H and 7I), suggesting that 20 mA cm⁻² was too high of a current density to enforce homogeneous underlimiting current densities even with surface charges. Still, there were differences found in different charge combinations at this current density, as the morphology became more layer-like at the later stage of deposition for the positive-negative pair (FIG. 7L) compared to the negative-negative pair (FIG. 7K), suggesting a more homogeneous current distribution.

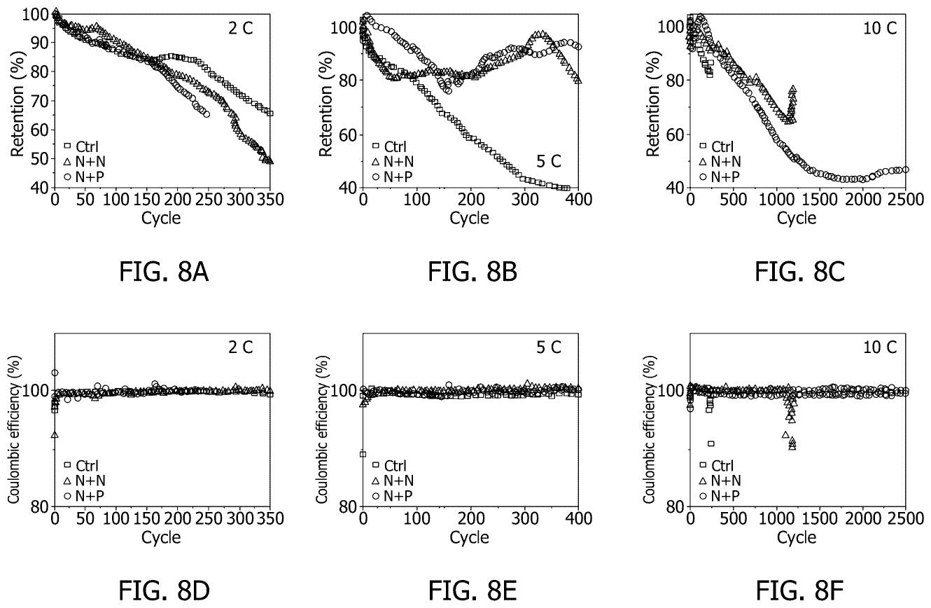

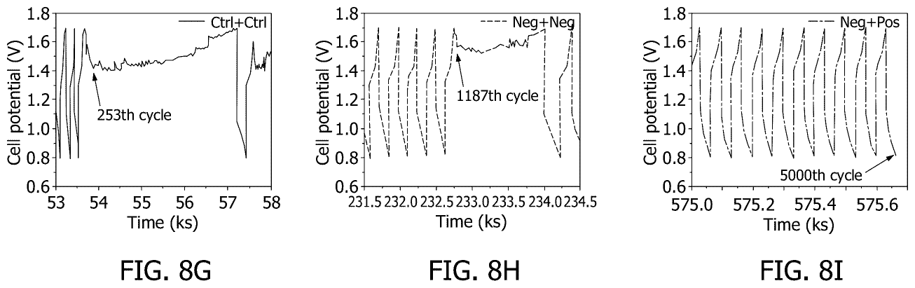

Referring to FIGS. 8A-8I, penetration-free cycling of dual-ion full cells with bipolar separators is demonstrated. In particular, FIGS. 8A-8I depict cycling performances of Zn—LiFePO₄ dual-ion full cells with different surface charge separator pairs. In FIGS. 8A and 8D, a charge and discharge rate of 2 C (0.8 mA cm⁻²) was used, and the initial discharge capacity was 45 mAh g⁻¹. In FIGS. 8B and 8E, the cells were charged and discharged with the rate of 5 C (2 mA cm⁻²), and the initial discharge capacity was 30.7 mAh g⁻¹. In FIGS. 8C and 8F, the cells were charged and discharged with the rate of 10 C (4 mA cm⁻²), and the initial discharge capacity was 21.5 mAh g⁻¹. FIGS. 8G and 8H depict charge and discharge curves for the selected curves from 10 C cycling. FIG. 8G depicts the control, at the penetrated cycle. FIG. 8H depicts Neg+Neg, at the penetrated cycle. FIG. 8I depicts the Neg+Pos, at the end of the 5000^{th} cycle.

To examine the practical effectiveness of the bipolar separators, a dual-ion full cell with LiFePO₄ (LFP) cathode and Zn metal anode was fabricated. For this system, only the Li-ions would intercalate and de-intercalate in the LFP cathode while only the Zn ions would plate/strip on the metal anode during the charging and discharging process. Similarly, two layer separators with different charges were stacked together and tested in a split cell. 1 M Li₂SO₄+0.2 M ZnSO₄ aqueous solution was used as an electrolyte, and the cells were tested with 3 different charge/discharge rates, 2 C (0.8 mA cm⁻²), 5 C (2 mA cm⁻²), and 10 C (4 mA cm⁻²).

For the lowest rate tested, 2 C (0.8 mA cm⁻²), the cells with treated and untreated separators showed very similar cycle performance for the first ˜150 cycles and showed an overall similar trend. This is expected since the effects from the EDLs will only reveal at high enough current densities where the local concentration depletion would occur. As the results from the symmetric cell suggest, a rate of 2 C is not enough for the local concentration depletion, resulting in a minor improvement. In contrast, the effect of enhanced ion transportation was more apparent for higher C-rates. For 5 C (2 mA cm⁻²), the treated separators maintained around 80% retention while the untreated separators showed retention under 40% at the 400^{th} cycle. At 10 C (4 mA cm⁻²), not only that the retentions of treated separators were better, but the point of cell penetration (which appears as a sudden drop of the coulombic efficiency) was significantly delayed, especially for the bipolar separators which still did not show a sign of penetration until 5,000^{th} cycle at 10 C. This suggests that the dendrite-blocking mechanism of positive pores was indeed effective, while the enhanced ion transport from the negative pores was still utilized. The key reason that 10 C showed the most apparent improvement compared to the lower charge/discharge rates is that the current density at this rate was 4 mA cm⁻², a value very close to the optimal current density (5 mA cm⁻²) that was observed in symmetric Zn cells. Again, this current density (which is lower than the limiting current density but higher than the threshold current density of local dendrite formation) benefited the most from the autonomous ion transport dynamics within charged pores and the more homogenized current distribution toward the electrode, which enabled a transition from mixed control to full activation control. Analogous to the observation in the Zn symmetrical cells described above, the higher C-rates are expected to have less enhancing effects since the deposition would be mostly diffusion controlled even with the improved transport via surface conduction.

### Conclusion

Described herein is a proof-of-concept bipolar separator to exploit the electrokinetic effects from both the negative and positive pore-wall charges. While with positive separators the cell suffered from significantly hindered cation transport which led to early cell failures, the negative-positive separator pair resulted in a delayed cell penetration which was around 6 times longer compared to the control cell. While the enhancement was due to the surface conduction of cations and a homogeneous current distribution, the most significant improvements were discovered in the underlimiting current densities. Post-mortem images of the Zn electrode and separators show that a current density of ˜1/3 of the limiting current density results in the most significantly stabilized current distribution. In dual-ion full cells with a Zn anode and LFP cathode, the negative-positive separator pair lasted 5,000 cycles with a 10 C rate without signs of penetration, while our control cells only lasted around 300 cycles. Even though the cells did not show the most optimized performance in terms of specific capacity, it is believed that performance can be further improved by a holistic design of the surface charge density, electrolyte concentration, and pore sizes. Exploiting bipolar separators for non-aqueous systems with alkali metal anode will enable new pathways toward the next generations of safer and more efficient high-energy batteries.

### Materials and Methods

### Separator and Glass Capillary Treatment

For the charged porous separators, the method of Han et al., Sci. Rep., 6, 1-12 (2016), was followed for the sample preparations. Polyelectrolytes were used to add negative and positive charges to the glass capillary walls and porous separators. Polydiallyldimethylammonium chloride (pDADMAC, Mw˜200 k-350 k, 20% in water, Aldrich) and poly(styrenesulfonate) (pSS, Mw˜70 k, Aldrich) in 0.2 M NaCl (99%, Aldrich) aqueous solution was used as a positive and negative polyelectrolyte, respectively. The ratio of the mixture was 2.5 ml pDADMAC:500 ml of NaCl solution for positive polyelectrolyte and 1 mg PSS:1 ml NaCl solution for negative polyelectrolyte. Ceramic-coated polyethylene membrane (MTI corp.) was plasma-treated for better wettability before being immersed inside the corresponding polyelectrolyte (Plasma-cleaner, 7 minutes per one side). After being submerged inside the polyelectrolyte for 24 hours, the separators were rinsed 2 times in deionized water before being dried in a vacuum oven at 40 C for 24 hours. For the addition of negative charges, positive charges were deposited first so that the negative charges can be more easily attached.

For the charged glass capillaries, the capillaries (VWR, 5 μL Micropipets) were pulled and then immersed in the corresponding polyelectrolytes for 30 minutes. The treated capillaries were washed with deionized water and dried in a vacuum oven at 40° C. for 24 hours. Similar to the separator treatment, the negative charges were deposited with a 2-step treatment, with negative charges being deposited after the deposition of positive charges.

### Fabrication of the Cells

Micro-scale glass capillary cells were fabricated with corresponding glass capillaries and two Zn wires as electrodes (D=0.05 mm, 97% purity). For the Zn symmetric cells, Split cells purchased from MTI were assembled with Zn foil as electrodes (D=8 mm) and corresponding charged and non-charged separators. For both the glass capillary and Zn symmetric split cells, 0.1 M Zinc trifluoromethanesulfonate (Zn(OTf)₂, 98%, Aldrich) solution was used as an electrolyte. For cathode in a full cell, LiFePO₄ (LFP, MTI Corp.), conductive carbon, and PVDF binder (MTI Corp.) were mixed in N-Methylpyrrolidone, NMP (Aldrich) with a mass ratio of (8:1:1) to form a slurry, which was then was film-casted on a carbon paper with a thickness of 200 um. The carbon paper with slurry was dried under vacuum at 120° C. before being assembled in a split cell. 0.2 M ZnSO₄+1M Li₂SO₄ aqueous solution was used as an electrolyte for the full cell testing.

### Characterization

For electrochemical testing of the capillary cells, Gamry potentiostat (Reference 600+, Gamry Instruments) was utilized. An optical microscope (MU500, AmScope) was used to take operando optical images of the capillary cells during chronopotentiometry. For the one-way deposition of Zn symmetric cells and the cycling of Zn-LFP full cells, a LAND battery tester was used. For SEM imaging, Thermofisher Quattro S Environmental SEM was utilized.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electrode assembly for an energy storage device, the electrode assembly comprising:
an electrode;
a counter electrode; and
a separator between the electrode and the counter electrode, the separator including a porous medium defining opposing major surfaces facing the electrode and the counter electrode, respectively, a first charged layer located at a first of the major surfaces, and a second, oppositely charged layer located at a second of the major surfaces.

2. The electrode assembly of claim 1, wherein the electrode is an anode, the counter electrode is a cathode, the first charged layer is a positively charged layer and faces the cathode, and the second charged layer is a negatively charged layer and faces the anode.

3. The electrode assembly of claim 2, wherein the positively charged layer includes a positively charged polymer and the negatively charged layer includes a negatively charged polymer.

4. The electrode assembly of claim 3, wherein:
the positively charged polymer is selected from the group consisting of poly(diallyldimethylammonium chloride), poly(N-methyl-4-vinylpyridinium iodide), poly(allylamine hydrochloride), poly(butyl acrylate-co-N-methyl-4-vinylpyridinium iodide), poly(butadiene-co-N-methyl-4-vinnylpyridinium) iodide, poly(styrene-co-4-vinylpyridine), poly(ethyl acrylate-co-4-vinylpyridine), polyaniline-based polymers, and polypyrrole-base polymers, and
the negatively charged polymer is selected from the group consisting of poly(styrenesulfonate), poly(sodium styrene sulfonate), poly(acrylic acid) sodium salt, poly(acrylic acid)-co-polymers, (poly(styrene-co-sodium styrenesulfonate), poly(sulfone-co-sodium sulfonate), poly(ethy acrylate-co-sodium acrylate), poly(butadiene-co-lithium methacrylate), poly(ethylene-co-sodium methacrylate), poly(ethylene-co-magnesium methacrylate), zinc-sulfonated ethylene-propylen-terpolymer, and carboxymethyl cellulose sodium salt.

5. The electrode assembly of claim 3, wherein the positively charged polymer includes poly(diallyldimethylammonium chloride) and the negatively charged polymer includes poly(styrenesulfonate).

6. The electrode assembly of claim 2, wherein the separator is impregnated with an electrolyte comprising charge carrier ions selected from the group consisting of lithium ions, zinc ions, sodium ions, potassium ions, calcium ions, magnesium ions, and combinations thereof.

7. The electrode assembly of claim 6, wherein the negatively charged layer regulates transport of the charge carrier ions through the porous medium and the positively charged layer facilitates autonomously blocking metal dendrite growth within the porous medium.

8. The electrode assembly of claim 6, wherein the charge carrier ions are lithium ions, zinc ions, or a combination thereof.

9. The electrode assembly of claim 6, wherein the electrolyte is an aqueous electrolyte.

10. The electrode assembly of claim 6, wherein the electrolyte is a non-aqueous electrolyte.

11. An energy storage device comprising one or more electrode assemblies, each electrode assembly comprising:
an electrode;
a counter electrode; and
a separator between the electrode and the counter electrode, the separator including a porous medium defining opposing major surfaces facing the electrode and the counter electrode, respectively, a first charged layer located at a first of the major surfaces, and a second, oppositely charged layer located a second of the major surfaces.

12. The energy storage device of claim 11, wherein, for each electrode assembly, the electrode is an anode, the counter electrode is a cathode, the first charged layer is a positively charged layer and faces the cathode, and the second charged layer is a negatively charged layer and faces the anode.

13. The energy storage device of claim 12, wherein, for each electrode assembly, the positively charged layer includes a positively charged polymer and the negatively charged layer includes a negatively charged polymer.

14. The energy storage device of claim 12, wherein, for each electrode assembly, the separator is impregnated with an electrolyte comprising charge carrier ions selected from the group consisting of lithium ions, zinc ions, sodium ions, potassium ions, calcium ions, magnesium ions, and combinations thereof.

15. The energy storage device of claim 14, wherein, for each electrode assembly, the negatively charged layer regulates transport of the charge carrier ions through the porous medium and the positively charged layer facilitates autonomously blocking metal dendrite growth within the porous medium.

16. The energy storage device of claim 14, wherein the charge carrier ions are lithium ions, zinc ions, or a combination thereof.

17. The energy storage device of claim 14, wherein the electrolyte is one of an aqueous electrolyte and a non-aqueous electrolyte.

18. A method of assembling an electrode assembly, the method comprising:
preparing a cathode by applying a cathodically active material to a cathode current collector;
preparing an anode by applying an anodically active material to an anode current collector;
preparing a separator by forming a positively charged layer that defines a first surface of a porous medium and forming a negatively charged layer that defines a second surface of the porous medium; and
positioning the separator between the cathode and the anode such that the positively charged layer faces the cathode and the negatively charged layer faces the anode.

19. The method of claim 18, wherein forming the positively charged layer on the first surface of the porous medium comprises immersing the porous medium in a positively charged polyelectrolyte solution, and wherein forming the negatively charged layer on the second surface of the porous medium comprises immersing the porous medium in a negatively charged polyelectrolyte solution.

20. The method of claim 18, wherein the porous medium is made directly from the positively charged layer and the negatively charged layer.
